(19) United States
(12) Patent Application Publication
(10) Pub. No.: US 2010/0200372 A1
(43) Pub. Date: Aug. 12, 2010

(54) CONVEYOR SYSTEM

(75) Inventors: Peter KRUPS, Anhausen (DE); Matthias KRUPS, Konigswinter-Vinxel (DE)

Correspondence Address: Clements Bernard PLLC, 1901 Roxborough Road, Suite 250, Charlotte, NC, 28211, US

(73) Assignee: Ceratis GmbH, Dernbach (DE)

(21) Appl. No.: 12/703,920

(22) Filed: Feb. 11, 2010

(30) Foreign Application Priority Data
Feb. 12, 2009 (DE) 10 2009 008 711.7

(51) Int. Cl. B65G 13/071

(52) U.S. Cl. 198/789

(57) ABSTRACT

A conveyor system, which in particular is a roller conveyor, has freely rotatable supporting rollers (16) as well as transmission elements (26) driven by shafts (18). The transmission elements (26) are disc-shaped and engage into slot-shaped recesses (48) formed in the bottom face (34) of a workpiece carrier (30). In a curve and/or branch (86), no disc-shaped transmission elements (26) are provided. The workpiece carrier (30) is moved in a curve and/or branch (86) by driven conveyor rollers (90) provided there. The conveyor rollers (90) transmit force to the bottom face (34) of the workpiece carrier (30) by friction.

### BACKGROUND OF THE INVENTION

1. Field of the Invention

The invention refers to a conveyor system, in particular a friction conveyor system, comprising a conveyor means such as a roller conveyor, a belt conveyor or a plate conveyor, on which conveyor means workpiece carriers are loosely placed. In particular, the invention refers to a roller conveyor in which the workpiece carriers are displaced by means of friction.

2. Description of Related Art

Especially in mass production, conveyor means are used to transport workpieces between individual workplaces where the workpieces are assembled or worked upon, for instance. For this purpose, the workpieces are arranged on workpiece carriers which are moved together with the workpieces by corresponding conveyor means. When workpiece carriers are to be moved, friction conveyors are known to be suitable means. With friction conveyors, the workpieces are not fixedly connected with conveyor means but rest on rollers, for instance. The movement of the workpiece carriers is effected by friction forces occurring between the rollers, belts or plates and the friction surfaces of the workpiece carriers. It is a particular advantage of friction conveyors that a back-up of workpiece carriers is possible. Here, in a back-up process, for instance with roller conveyors, the corresponding drive means of the friction rollers slip, because they are suitably provided with friction clutches. Friction clutches require no intricate and complicated disengaging from a conveyor means, such as a chain.

Further, friction conveyors have the advantage that curves and especially branches can be realized in a simple manner. Using branching means such as switches, individual workpiece carriers can be introduced into or diverted from the flow. Thus, friction conveyors are highly flexible. Such a friction conveyor is described in DE 40 36 214.

Since, in the case of friction conveyors, the workpiece carriers have to be stopped at the individual workplaces by back-up processes, the driven rollers or conveyor elements must be provided with friction clutches. Such friction clutches are expensive and maintenance-intensive. Further, it is required to adjust or set friction clutches so as to define the torque limit above which the friction clutch will slip. Because of wear, the setting has to be checked in regular intervals.

In order to stop the workpiece carriers at working stations, before switches or the like, it is known to provide stop means. For instance, these comprise a rod-shaped vertically directed element protruding beyond the surface of the friction conveyor. The workpiece carrier runs against the stop means and is thus held at the corresponding position. To release the workpiece carrier, the stop means is removed from the trajectory of the workpiece carrier. Especially with rod-shaped stop means, this is done by moving the stop means downward in the vertical direction.

From DE 195 39 844 C2, a friction conveyor system is further known in which individual driven conveyor elements, such as rollers, comprise disc shaped transmission elements for an acceleration of the workpiece carriers. These disc-shaped transmission elements, which may comprise toothings, engage in a longitudinally extending slot in the workpiece carrier, which slot includes a toothed rack, for instance. Such additional transmission elements can be used to accelerate a workpiece carrier.

When combined with a friction element movably integrated in the workpiece carrier, as described in the posteriorly published DE 10 2007 040 908, friction conveyors with disc-shaped transmission elements that engage in slot-shaped recesses provided in the bottom side of the workpiece carrier are advantageous in that it is possible, when the workpiece carrier is stopped at a working station or in a back-up situation, to separate the disc-shaped transmission elements from the transmission portion such as the friction portion provided in the slot of the workpiece carrier. This can be achieved by two motion elements arranged within the workpiece carrier for the transmission of friction forces.

At curves or branches, however, it is not possible to move the workpiece carrier by means of such disc-shaped transmission elements that engage in slot-shaped recesses in the bottom face of the workpiece carrier, since, at a curve or a branch, the workpiece carrier must be moved transversely to its conveying direction. In doing so, the workpiece carrier slips over the rollers on which the bottom face of the workpiece carrier rests. Such a lateral displacement of the workpiece carrier on the rollers, necessary at branches or bends, is not possible when disc-shaped transmission elements are provided that engage in slot-shaped recesses in the bottom face of the workpiece carrier.

### SUMMARY OF THE INVENTION

It is an object of the invention to provide a conveyor system, especially a roller conveyor, allowing to realize curves and branches in a simple manner. In addition, it is preferably provided to allow for a simple back-up situation.

The conveyor system of the present invention which, in particular, is a roller conveyor, wherein the workpiece carriers are preferably moved at least partly by means of friction forces, comprises freely rotatable supporting rollers. The bottom face of the workpiece carriers rests on the support rollers. Thus, the supporting rollers absorb the load of the workpiece resting on the workpiece carrier. Since the supporting rollers are freely rotatable, they are not used to drive or move the workpiece carrier. Rather, the supporting rollers can be of simple structure and be held in a frame of the conveyor system through ball or sliding bearings in a manner free to rotate. Further, the conveyor system preferably comprises disc-shaped transmission elements engaging in slot-shaped recesses in the bottom face of the workpiece carrier. The drive elements thus transmit force within the slot-shaped recess in the bottom face of the workpiece carrier to the same. The transmission of force may be achieved, for instance, by providing the slot with a toothing, such as a toothed rack, cooperating with a chain so that the transmission of force is achieved by a form fit. Preferably, however, the drive elements are designed as disc-shaped transmission elements. These may be discs with a toothing along the circumference thereof which also mesh with the toothed rack in the slot-shaped recess. However, it is particularly preferred that the force transmission is not achieved by form fit, but by friction fit. Therefore, an inner face of the slot-shaped recess is provided with a friction surface for the transmission of force, the peripheral surface of the disc-shaped transmission elements abutting against the same for the transmission of force.

The conveyor system of the present invention has driven conveyor rollers in a curve or branch portion. The conveyor rollers are configured such that the bottom face of the workpiece carrier rests on the outer side of the conveyor rollers. The driven conveyor rollers move the workpiece carrier through friction forces transmitted from the conveyor rollers to the bottom face of the workpiece carrier. In curves or branches, the invention thus provides no drive elements that would engage in the at least one slot-shaped recess of the workpiece carrier. Rather, the transmission of force is effected on another level, i.e. the bottom face of the workpiece carrier. Thereby, it is possible to displace the workpiece carriers laterally on the conveyor rollers. The workpiece carrier can thus be deflected from its direction of movement by laterally directed displacement on the conveyor rollers.

The curves and/or branches of the present conveyor system are preferably exclusively provided with conveyor rollers and supporting rollers. In a particularly preferred embodiment, the dimensions and the design of the supporting rollers and the conveyor rollers are identical. Thus, the conveyor rollers differ from the supporting rollers merely in that they are driven rollers. In a preferred embodiment it is possible that the conveyor rollers comprise no friction clutches but are driven continually, in particular. This is achieved by providing corresponding sensors which guarantee that there is always only one workpiece carrier in a curve and/or branch portion and that there is sufficient space for a workpiece carrier at the end of the curve or branch, i.e. at the transition to the straight conveyor path. Thus, it is made sure that no back-up of workpiece carriers occurs in the curve and/or branch portion. In particular, a stop means is provided before a curve and/or branch, seen in the conveying direction, which stop means stops a following workpiece carrier before the curve and/or branch if there is a workpiece carrier present in the curve and/or branch.

According to the invention, the conveyor system has a first contact plane formed by the supporting rollers and the conveyor rollers. The bottom face of the workpiece carrier rests on the first contact plane. A second contact plane is formed by the preferably horizontal inner surface of the at least one slot-shaped recess formed in the workpiece carrier. The second contact plane serves to transmit conveying forces to the workpiece carrier body via the preferably disc-shaped transmission elements. Thus, the second contact plane is spaced horizontally from the first contact plane and, in particular, is arranged on a higher level than the first contact plane. To avoid obstructing a passage, the lateral dimension of the shafts of the drive elements extends only to the transmission elements.

In order to realize branches for connecting two in particular mutually perpendicular conveyor paths, one of the conveyor paths is provided with a deflector element to divert the workpiece carrier, e.g. by 90°, onto the other conveyor path. Preferably, the deflector element is displaceable and/or pivotable so that it can be shifted or pivoted into the first conveyor path. The inner side of the deflector element, against which the workpiece carrier abuts, is of concave shape, in particular. For a deflection angle of 90°, the inner side of the deflector element is preferably designed as a quadrant.

To stop the workpiece carrier in front of a curve and/or branch or at a working station, the conveyor system preferably comprises a stop means. The stop means which may be embodied as a pin, for instance, is preferably adapted to be moved into the conveyor path of the workpiece carrier. This is effected by pivoting or shifting the stop means, with a vertical shifting of the stop means being preferred, so that the stop means is shifted upward into the conveyor path in order to activate the stop means. A workpiece carrier will thus be moved against the stop means and will be stopped in front of a curve or branch, for instance. Preferably, the workpiece carrier and/or the stop means are configured such that, when the workpiece carrier is stopped by the stop means, the at least one preferably disc-shaped transmission element is uncoupled from the workpiece carrier. This is achieved, in particular, by displacing a friction element connected with the workpiece carrier, so that the drive element for the transmission of drive forces no longer contacts the friction element.

Such stop means are arranged preferably exclusively between adjacent supporting rollers and/or drive elements. Thus, the stop means are situated preferably exclusively in straight portions of the conveyor system, in particular, and not in curves or branches. This is advantageous in that driven conveyor rollers, especially continually driven conveyor rollers, can be provided in curves and/or branches since no workpiece carriers are stopped or backed up in these sections. Preferably, these sections and especially the end section of curves or branches are monitored in a suitable manner using suitable sensors.

According to the invention, the friction portion contacted or engaged by the transmission element is preferably arranged on a friction element connected with the workpiece carrier. Preferably, the friction element is connected with the workpiece carrier in a movable manner. Further, the friction element is preferably connected with an actuator element. The actuator element makes it possible to move the friction element. By moving the friction element, a distance can be created between the transmission element and the friction element and/or the friction between these two elements can be reduced by reducing the contact pressure. Thus, the actuator element is used to move the friction element so that the distance between the friction element and the transmission element increases, preferably such that a gap is formed between both elements. The actuation of the actuator element thus causes disengagement of the transmission element and the friction element, wherein, according to the invention, disengagement also includes a reduction of the friction between the two elements.

The actuator element may be activated by a stop element near a workplace or by a back-up of the workpiece carriers. Thus, a stopping of the workpiece carrier always causes a disengagement of the transmission element and the friction element. This offers the advantage intended by the invention that it is possible to provide conveyor elements without friction clutches, since the driven conveyor elements can rotate freely as soon as the friction element and the transmission element are disengaged. At least, friction clutches of a substantially simpler structure can be provided, which will then substantially serve as an additional safety feature.

The friction conveyor system of the invention is particularly well suited for the transport of workpieces having a weight of less than 250 kg. With such friction conveyor systems, the workpiece carrier preferably rests immediately on the conveyor elements without any additional supporting elements, such as supporting rollers on the workpiece carrier.

Preferably, the friction elements are provided in a recess of the workpiece carrier or of the base body of the workpiece carrier. In particular, the recess is slot-shaped. In a preferred embodiment, at least two especially slot-shaped recesses are provided in every workpiece carrier. The recesses preferably extend in the longitudinal direction or the conveying direction along the entire length of the workpiece carrier. Preferably, both recesses are arranged in parallel to each other. Preferably each recess is open at the ends so that a transmission element, for instance a disc-shaped transmission element, is easily introduced into the recess.

The friction element, which preferably is arranged within the recess, is of a rod-shaped design in a preferred embodiment. In particular, it is a rod of rectangular cross section, wherein the face directed to the transmission element of the conveyor elements can show an increased roughness. Preferably, the friction element extends over substantially the entire length of the workpiece carrier. The friction element extends at least over three quarters of the length of the workpiece carrier. Thus, the distance between the driven conveyor elements can be increased correspondingly.

The actuator element may be an electrically and/or magnetically driven actuator element, for instance. The actuator element may comprise a sensor, for instance, which detects a back-up or stop situation. Upon the detection of a back-up or stop situation, the friction element is moved by means of the actuator element.

In a particularly preferred embodiment of the invention, the actuator element is of mechanical design. In particular, the actuator element is fixedly connected with the at least one friction element, especially the two friction elements provided per workpiece carrier. Here, the actuator element may protrude beyond the front end of the workpiece carrier in the manner of a bumper, such an actuator element especially actuating the friction element in a back-up situation. Preferably, another actuator element is provided that is actuated by a stop means. Such an actuator element, preferably connected directly or indirectly with the friction element(s) via an intermediate element, is provided in particular on the bottom face of the workpiece carrier. In particular, such an actuator element is arranged in a slot provided in the bottom face of the workpiece carrier, wherein, in a stop situation, a pin of the stop means is inserted into the slot and the workpiece carrier abuts against the stopper guided in the slot. Such an actuator means is therefore arranged in particular in the region of the bumper element, such as the transverse side of the slot, against which the pin of the stop means bumps. In the stop position of the workpiece carrier, in which the holder element cooperates with the stop means to prevent the workpiece carrier from being pushed or shoved back, such an actuator element is preferably also actuated at the same time. Here, the disengagement of the friction elements from the conveyor elements is effected simultaneously with the cooperation of the holder element and the stop means in the stop position.

It is thus possible to provide two separate actuator elements, one for lifting the friction element in a back-up situation, and another for use in a stop situation. Here, both actuator elements are preferably fixedly connected with the at least one friction element. Possibly, the actuator elements may also be two separate actuator elements. Depending on the position and the design of the actuator element actuated by the stop means, it is also possible to provide only a single actuator element that is actuated both in a back-up and a stop situation.

When a workpiece carrier is driven against a stopper or when a workpiece carrier bumps into another workpiece carrier ahead thereof or into an obstacle, the actuator element is thus displaced towards the workpiece carrier. Due to the preferably rigid mechanical connection of the actuator element with the at least one friction element, the motion of the actuator element thus caused automatically also causes a movement of the at least one friction element, preferably both friction elements. By this movement, the friction element reaches the disengaged position so that the friction between the friction portion provided on the friction element and the transmission element is at least reduced, preferably both elements are moved a distance apart from each other.

In the friction conveyor system of the present invention the driven disc-shaped transmission elements substantially serve to drive or convey the workpiece carriers. The weight of the workpiece carrier and the workpiece is substantially absorbed by the non-driven supporting rollers or, in curves and/or branches, by the driven conveyor rollers.

The driven conveyor elements, i.e. the in particular disc-shaped transmission elements as well as the conveyor rollers, are preferably driven by electric motors. It is possible in this context to drive a plurality of such conveyor elements in common by a common electric motor in combination with a transmission or a chain. This is particularly advantageous with mutually adjacent conveyor rollers as they are provided in curves and/or branches.

### BRIEF DESCRIPTION OF THE DRAWINGS

The following is a detailed description of a preferred embodiment of the invention with reference to the accompanying drawings.

In the Figures:

FIG. 1 is a schematic top plan view on a friction conveyor with a workpiece carrier,

FIG. 2 is a schematic sectional view along line II-II in FIG. 1, with the transmission elements in engagement with the friction elements,

FIG. 3 is a schematic view corresponding to FIG. 2, however, with the friction elements being in the disengaged position with respect to the transmission elements,

FIG. 4 is a schematic sectional view along line IV-IV in FIG. 1, with a stop means in the stop position,

FIG. 5 is a schematic sectional view along line V-V in FIG. 4, and

FIG. 6 is a schematic top plan view on a branch of a friction conveyor.

### DESCRIPTION OF PREFERRED EMBODIMENTS OF THE INVENTION

The friction conveyor system comprises a conveyor means 10. The conveyor means 10 has frames 14 extending in the longitudinal or conveying direction 12. In addition, the conveyor system may comprise switches and curves not illustrated in the Figures. In the embodiment illustrated, the frames 14 support freely rotatable supporting rollers 16 and conveyor rollers 18. The supporting rollers are supported in a freely rotatable manner in the frames 14 through axes 20 and corresponding bearings. In the embodiment illustrated, the driven conveyor elements (conveyor rollers 18) also extend over the entire width of the conveyor means 10 such that one side of the driven conveyor rollers 18 is supported for free rotation in the frame 14 via a shaft 20. The second shaft 22 of the driven conveyor means 18 is driven by and connected with an electric motor 24.

In the embodiment illustrated, the conveyor rollers 16 that are not driven and the driven conveyor elements 18 extend over the entire width of the conveyor means 10. Likewise, individual conveyor elements can be connected with the two opposite frames 14 so that a free space or passage is formed between the conveyor elements. Thus, the workpieces are also accessible from below, provided the workpiece carrier also has a corresponding passage.

In the embodiment illustrated, the driven conveyor rollers 18 comprise two disc-shaped transmission elements 26. The two disc-shaped transmission elements 26 are spaced apart and, in the embodiment illustrated, they are supported by a cylindrical roller 28. The cylindrical roller 28 has a smaller outer diameter than the likewise cylindrical supporting rollers 16 that are not driven.

A workpiece carrier 30 rests on the upper surface of the conveyor means 10 and is moved in the direction of the arrow 12 by means of the driven conveyor rollers 18.

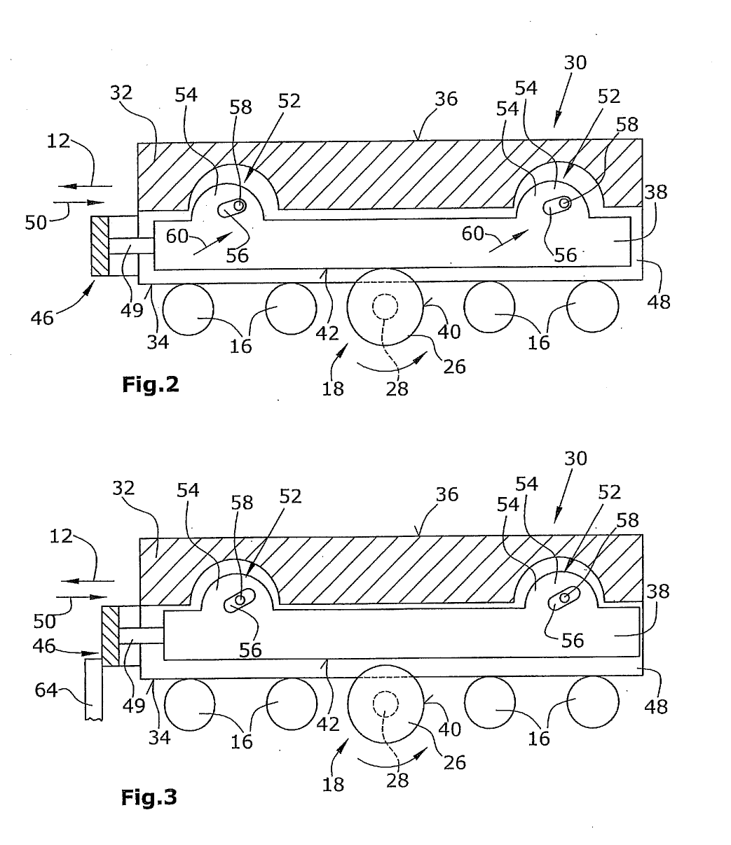

The workpiece carrier 30 comprises a base body 32. The bottom face 34 thereof (FIG. 2) rests on the non-driven, freely rotatable supporting rollers 16. Thus, the supporting rollers 18 substantially serve to receive the workpiece arranged on the top surface 36 of the workpiece carrier 30.

In order to move the workpiece carrier 30 in the conveying direction 12, friction elements 38 contact the transmission elements 26 during movement (FIG. 2). For this purpose, the disc-shaped transmission elements 26 have a cylindrical shell-shaped surface 40 that abuts against a friction portion 42 of the friction element 38, the friction portion being planar, in particular. Preferably, the friction element has a rectangular cross section so that the friction portion 42 presents a planar surface extending over the entire length of the friction element 38. By rotating the driven conveyor rollers 18 in the direction of the arrow 44, the workpiece carrier 30 is transported in the direction of the arrow 12 (FIG. 2).

For a stopping of the workpiece carrier, for example at a working position or upon a back-up of a plurality of workpiece carriers, the friction elements 38, two of which are provided in the embodiment illustrated that extend over the entire length of the workpiece carrier 30, are connected with an actuator element 46. The actuator element 46 designed in the manner of a bumper is rigidly connected with the two friction elements 38 through in particular rod-shaped connecting elements 49.

The friction elements 38, each arranged in a slot-shaped recess 48 of the workpiece carrier 30, are thus moved forcibly in the slot 48 when the actuator element is pushed in the direction of the arrow 50. This is effected by bumping into a stop element or by bumping into another workpiece carrier ahead of the workpiece carrier 30 in the conveying direction. Due to the mechanical connection between the actuator element 46 and the two friction elements 38, no sensor or electric drive is required for moving the friction elements into a disengaged position. Rather, the friction elements 38 are moved by shifting the actuator element 46 in the direction of the arrow 50.

To guarantee a displacement of the friction elements 38 into the disengaged position, two motion elements 52 are further provided, which in the embodiment illustrated are rigidly connected with the friction elements 38. Two motion elements 52 are provided per friction element 38. In the embodiment illustrated, the motion elements 52 are tab-shaped projections 54 connected with the rod-shaped friction element 38, each projection having an elongate hole 56. The elongate hole 56 extends at an angle or obliquely to the conveyor means 12, with the elongate hole being inclined in the conveying direction 12. A projection 58, designed as a cylindrical pin in the embodiment illustrated, is provided in each of the two openings 56 in the form of elongate holes. The pin 58 is rigidly connected with the base body 32 of the workpiece carrier 30.

By moving the actuator element 46 in the direction of the arrow 50, the friction elements 38 are moved in the direction of the arrows 60, i.e. in parallel with the orientation of the elongate holes 56. Thereby, the friction elements 38 are moved into the disengaged position with respect to the transmission elements 26.

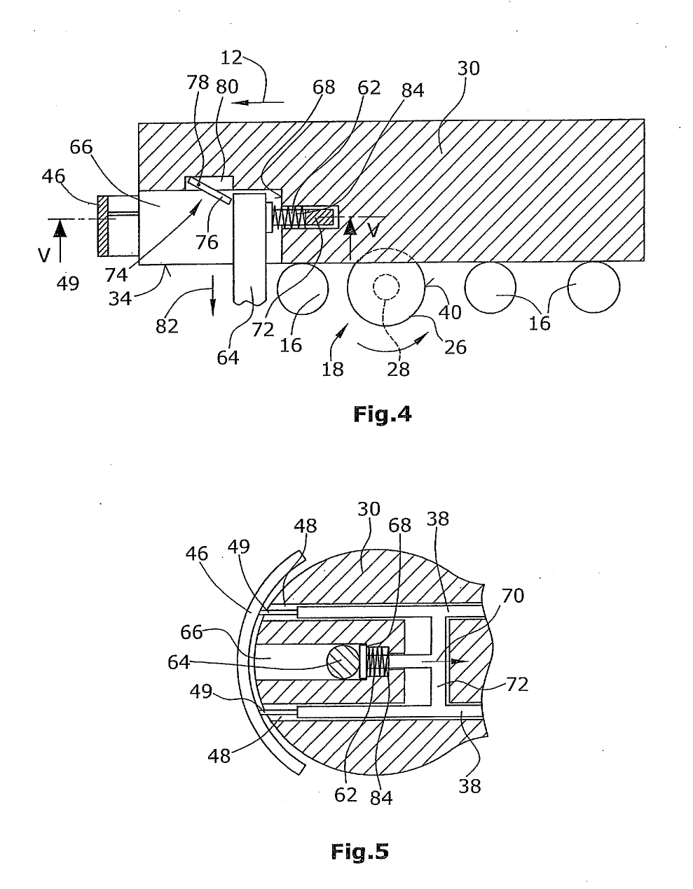

In the particularly preferred embodiment of the invention illustrated, the friction elements 38 may not only be shifted by moving the actuator element 46, but also by displacing the actuator element 62 (FIGS. 4 and 5). The actuator element 62 is an element to be actuated by a stop means, with one of the pins 64 of the stop means being schematically illustrated. When the workpiece carrier bumps against a stop means 64, the same first enters a slot 66 provided in the bottom face 34 of the workpiece carrier 30. The workpiece carrier 30 moves on in the direction of movement 12 until the pin 64 abuts against a rear wall or rear side 68 of the slot serving as a bump-on element or an abutment element. Thereby, the actuator element 62, which in the embodiment illustrated is pin-shaped, for instance, and arranged within the workpiece carrier 30, is displaced backward with respect to the workpiece carrier 30, i.e. in the direction of the arrow 70. A cross web 72 (FIG. 5) connects the actuator element 62 with the two friction elements 38 or the connecting elements 49 (FIGS. 2 and 3).

Thus, when the workpiece carrier 30 bumps into others in a back-up situation, the friction elements 38 are moved upwards by the bumper-like actuating element 46, the same as they are moved by the pin-like actuator element 62 when the workpiece carrier bumps against a stop means.

In particular the preferred embodiment of the invention illustrated, in which the friction elements 38 are separated from the transmission elements 26 in back-up and stop situations, involves the risk that the workpiece carrier bounces back against the direction of transport 12 after it has bumped against a stop means 64, whereby no defined position of the workpiece is guaranteed especially at working stations. According to the invention, a holder element 74 (FIG. 4) is therefore provided which cooperates with the stop means 64. In the embodiment illustrated, the holder element 74 comprises a small plate 76 made from metal, in particular. The small plate 76 is pivotable about an axis 78 that is eccentric with respect to the centre of gravity of the small plate 76. Due to the weight of the small plate 76, the same is always in the position illustrated in FIG. 4 regardless of whether a stop means 64 is in the slit 66 or not.

When bumping against a stop means 64, the stop means 64 pivots the small plate 76 upwards about its axis 78 into a recess 80. As soon as the holder element 74 has passed the stop means upon bumping against the stop means 64, as illustrated in FIG. 4, its weight makes the small plate 76 fall back into the position illustrated in FIG. 4. In this position, the holder element 74 fulfills its holding function, since the workpiece carrier can no longer move to the right in FIG. 4 should the workpiece carrier 30 bounce back.

The workpiece carrier 30 is conveyed on by actuating the stop means, the pin 64 of the stop means illustrated is shifted downward in the direction of the arrow 82 until it is fully below the bottom face 34 of the workpiece carrier 30. In this position, it is possible to pass over the pin 64. By withdrawing the pin 64, the two friction elements 38 again engage the supporting rollers 16. This may be effected by the weight of the friction elements 38, wherein the movement of the friction elements 38 may be assisted by a spring 84.

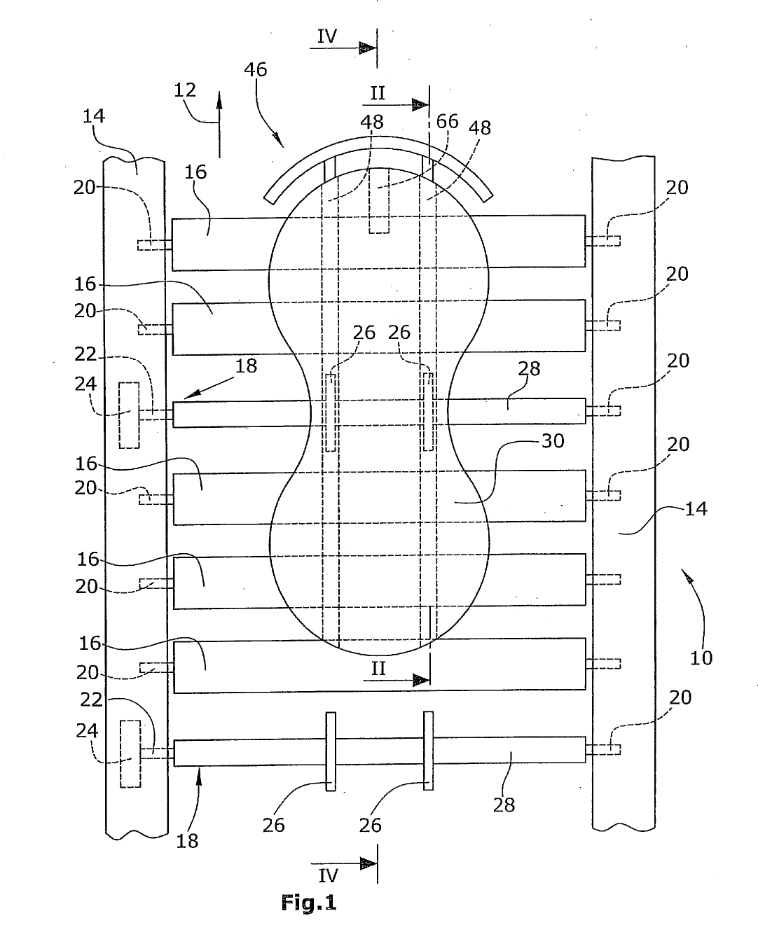

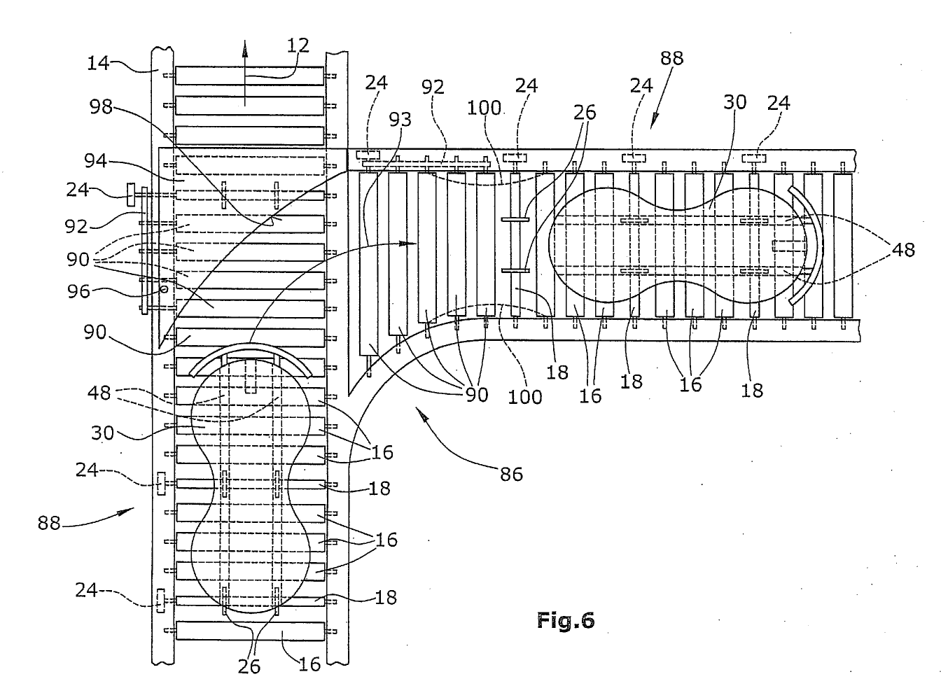

The top plan view on the conveyor system illustrated in FIG. 6 shows a branch 86. The branch 86 connects two straight conveyor parts 88 corresponding to the conveyor part described with reference to FIG. 1. For this purpose, driven conveyor rollers 90 are provided in the branch 86. The conveyor rollers 90 are driven via an electric motor 24 and a chain or belt drive 92. The conveyor rollers 90 have an outer diameter that substantially corresponds to the outer diameter of the supporting rollers 16. Since workpiece carriers are not stopped or backed-up within the branch 86 that is equipped exclusively with conveyor rollers 90 and includes no stop means, the conveyor rollers 90 can be driven continually and need no friction clutches.

To deflect the workpiece carrier 30 to the right in FIG. 2, as illustrated by the arrow 93, a deflector element 94 has been pivoted into the conveying direction 12 of the left workpiece carrier 30 in FIG. 6. For this purpose, the deflector element 94 is pivotable inward and outward about an axis 96. In the situation illustrated in FIG. 6, the workpiece carrier 30 thus bumps against a concave inner side 98 of the deflector element 94. Thereby, the left workpiece carrier 30 in FIG. 6 is turned to the right in the direction of the arrow 93 and slides to the right on the conveyor rollers 90 which extend from the left to the right in FIG. 6. This lateral displacement of the workpiece carrier 30 is carried on until the workpiece carrier 30 is engaged by the first roller 90 of the conveyor path 88 leading to the right, said rollers extending vertically in FIG. 6.

In order to make sure that the disc-shaped transmission elements 26 engage in the slot-shaped recesses 48 again, introduction elements 100 are provided which are shown in broken lines in the embodiment illustrated. These centre the workpiece carrier 30 on the conveyor path 88, since the outer sides of the workpiece carrier 30 abut against the introduction elements 100.

If the left workpiece carrier 30 in FIG. 6 is not to be deflected, the deflector element is pivoted about the axis 96 out of the trajectory 12. Of course, the deflector element can also be swiveled downward about an axis that is horizontal and parallel with respect to the frame 14, for instance.

Preferably, a stop device 64, as described in particular with reference to FIGS. 2-5, is provided in front of the branch 86. Using the stop means, workpiece carriers 30 can be stopped before entering the branch 86. Corresponding monitoring sensors can be used to make sure that a workpiece carrier only enters the branch 86 if no other workpiece carrier is present in the branch 86. Further sensors may be used to make sure that there is enough space for a workpiece carrier 30 also downstream of the branch 86 so that a workpiece carrier 30 will not back up on the conveyor rollers 90.

According to the invention, the conveyor system thus comprises two contact planes. The first contact plane is formed by the supporting rollers 16 and the conveyor rollers 90. Thus, the first contact plane is the plane on which the bottom face 34 (FIGS. 2-4) of the workpiece carrier 30 rests. In the branch 86, friction force is transmitted from the conveyor rollers 90 to the bottom face 34 of the workpiece carrier 30. The second contact plane is formed by the friction portion 42 of the friction elements 38. When conveying the workpiece carriers in a straight direction, the corresponding friction force is transmitted to the workpiece carriers 30, in this plane, via the disc-shaped transmission elements 26. The second contact plane formed by the friction portion 42 is on a higher horizontal level than the first contact plane formed by the bottom face 34. Further, the second contact plane may be lifted as described before in order disengage the workpiece carriers.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A conveyor system, in particular a roller conveyor, for moving workpiece carriers, especially by means of friction forces, comprising
freely rotatable supporting rollers for a bottom face of a workpiece carrier to rest thereon,
driven transmission elements engaging into slot-shaped recesses in order to transmit force, and
driven conveyor rollers provided in a curve and/or branch, on which rollers the bottom face of the workpiece carrier rests for the transmission of force by friction.

2. The conveyor system of claim 1, wherein curves and/or branches are exclusively provided with conveying rollers and, optionally, supporting rollers.

3. The conveyor system of claim 1, wherein a first contact plane formed by the supporting rollers and/or the conveyor rollers is spaced horizontally from a second contact plane formed by the drive elements.

4. The conveyor system of claim 1, wherein the transmission elements are disc-shaped and the transmission of force is preferably effected by friction.

5. The conveyor system of claim 1, wherein the supporting rollers and the conveyor rollers substantially have the same outer diameter.

6. The conveyor system of claim 1, wherein the transmission elements are arranged eccentrically with respect to the width of the workpiece carriers.

7. The conveyor system of claim 1, characterized by a deflector element for deflecting a workpiece carrier in a curve and/or at a branch, said deflector element in particular being pivotable and/or displaceable in a horizontal direction.

8. The conveyor system of claim 1, characterized by a stop means adapted to be moved into the transport path of the workpiece carrier.

9. The conveyor system of claim 8, wherein the stop means causes a disengagement of the at least one transmission element from the workpiece carrier, in particular from a friction element connected with the workpiece carrier.

10. The friction conveyor of claim 8, wherein the stop means is provided between adjacent supporting rollers and/or the drive elements.
